(19) United States
(12) Patent Application Publication
(10) Pub. No.: US 2020/0091856 A1
(43) Pub. Date: Mar. 19, 2020

(54) Solar module mounting apparatus with edge to edge waterproofing capabilities

(71) Applicant: John Wakeman, Ann Arbor, MI (US)

(72) Inventor: John Wakeman, Ann Arbor, MI (US)

(21) Appl. No.: 16/132,463

(22) Filed: Sep. 16, 2018

(51) Int. Cl. H02S 20/23; E04D 3/40; E04D 3/36; E04D 3/366

(52) U.S. Cl. CPC H02S 20/23; E04D 3/366; E04D 3/3606; E04D 3/40

(57) ABSTRACT

An apparatus is contemplated for creating a structure which simultaneously serves as both a building element and a photovoltaic power source. Components of the invention interface with modules which comprise photovoltaic solar panels. When used collectively, these modules are contemplated as comprising a replacement for a roof or other building component. When the present invention is used, a roof or other building component can be created without the need for a separate underlayment, and without the need for tiles or another outer waterproofing layer. This setup results in power generation, cost savings, and environmental advantages. Additionally, embodiments of the invention comprise fixed stop elements which ensure correct placement of modules on a frame assembly. The invention could also include other elements, including water gutters, grab steps which facilitate access, and specially positioned border covers to protect and aesthetically cover wired regions of solar modules.

### STATEMENT REGARDING FEDERALLY SPONSORED RESEARCH

Not applicable.

### BACKGROUND OF THE INVENTION

### 1. Field of the Invention

The present invention relates to an apparatus for creating a structure which simultaneously serves as both a building element and a photovoltaic power source.

Components of the invention interface with modules which comprise photovoltaic solar panels. When used collectively, these modules are contemplated as comprising a replacement for a roof or other building component. When the present invention is used, a roof or other building component can be created without a need for a separate underlayment, and without a need for tiles or another outer waterproofing layer.

This setup results in power generation, cost savings, and environmental advantages.

Additionally, embodiments of the invention comprise fixed stop elements which ensure correct placement of modules on a frame assembly. The invention could also include other elements, which greatly enhance the ability to provide service if a module requires replacement or repair. Examples of such elements include a random-access setup, which allows convenient removal of one module at a time without a need to remove other modules. Other examples of such elements include grab steps, which can be stepped on or held, thereby allowing a service technician to easily maneuver along a roof or other building surface when servicing its components.

### 2. Description of the Related Art

Several apparatuses are known in the art wherein photovoltaic solar panels can be mounted on top of a roof, used as a roof, or otherwise used as a building component or as an addition to a building.

There are a variety of ways in which such apparatuses are structured and designed. However, such apparatuses frequently have the disadvantage of requiring custom-built solar modules. While these other inventions might function as designed, using them is much more costly and commercially disadvantageous than would be the case with a system which could fit standard-sized solar modules. Such a system would take advantage of the fact that standard-sized solar modules have already achieved substantial manufacturing volume and economies of scale, lowering costs and increasing convenience. Hence, the present invention provides a system wherein standard, “off the shelf” modules could be used in this capacity.

Additionally, many of these designs are not well adapted for safe, easy access when maintenance or repair is needed. Any system which makes it difficult to install or maintain such an apparatus not only adds to labor costs, it can be hazardous to service technicians who need to work on it.

Additionally, existing designs often lack features which allow reproducible positioning of modules. If present, these features would ensure that every module is positioned consistently and would insure that after a module is removed, a replacement module will be positioned identically. Such features could also make it possible for a single person (rather than a two-person team) to install and position the modules correctly.

As such, it could significantly save time, expense, and other resources if a system existed allowing for easy and efficient installation, maintenance, and repair of buildings with modular components, such as those which incorporate solar panels or other photovoltaic technology.

### SUMMARY OF THE INVENTION

Briefly described, the invention comprises apparatuses for incorporating technology into a building, such as a building roof or such as siding on a wall of a building, which allows collection of solar energy and convenient servicing of apparatus components.

Embodiments of the invention are contemplated as providing a replacement for a building component. Specifically, these embodiments can be used in place of a roof, a wall, an overhang, or another building component, and therefore obviate the need to mount a solar array on top of an existing roof structure.

In general, the following disclosure discusses situations in which the invention is implemented as a replacement for a building roof. Despite this, it should be clear that embodiments are also contemplated wherein the invention is connected to, or used in place of, other building components, e.g. walls or overhangs.

Advantages of the present invention include minimization of costs by eliminating unnecessary materials, such as roof decking and/or underlayment.

Another advantage of the present invention might include a design wherein up-roof elements on a building overlap with down-roof elements, which allows rain water to flow down a roof surface without flowing under any modules or leaking into a building.

Another advantage of the present invention includes elimination of a need to use additional outer material, such as shingles or other outer-layer waterproofing.

Another advantage of the present invention includes elimination of holes or penetrations in an existing roof structure, which would normally be necessary to secure a roof-mounted solar apparatus but which would create a risk of leaks in the existing roof structure and would therefore require their own waterproofing or flashing.

Another advantage of the present invention includes elimination of a need for an underlying roof, and hence obviation of a need to remove and re-install a solar array in order to access, maintain, and/or repair said underlying roof.

Another advantage of the present invention could include a clamping system which allows module components to be securely held in position.

Another advantage of the present invention could include alignment stops, which ensure consistent positioning of modules.

Another advantage of the present invention includes a random-access design which allows every module to be removed without being blocked by any other module.

Another advantage of the present invention includes a lack of underlayment or other obstacles which could block access of a solar module assembly from below. A design incorporating this feature could be easily and safely serviced from underneath.

Another advantage of the present invention could include an ability to use standard photovoltaic solar modules, rather than requiring custom ones. This ability could be provided by particularized shaping, tapering, and/or construction of components.

Another advantage of the present invention could include specialized tapering of mounting components, allowing modules to be set at specified angles. This tapering could result in an apparatus which is capable of holding particular sizes of solar modules, and can also assist with setting modules in a way that optimizes waterproofing.

Another advantage of the present invention could include adaptations allowing frameless modules to be used.

Another advantage of the present invention could include a design which can cover an entire roof, from side to side and/or peak to gutter, thereby maximizing solar exposure, improving building aesthetics, and simplifying building construction.

Another advantage of the present invention could include a design which allows modules in one row to be offset from modules in other rows.

Another advantage of the present invention could comprise components such as plates which can cover empty areas, and which can link modules with conventional building components such as side eaves.

Another advantage of the present invention might include the use of one or more “grab steps” which can be held or stepped on by users such as a homeowner, technician, firefighter, or other first responder, thereby facilitating movement and enhancing safety. A further advantage of these grab steps is that they obviate the need for a separate walking area for technicians, thereby allowing an entire roof to be covered with solar modules and maximizing the photovoltaic potential of a building.

Another advantage of the present invention might include features such as grab steps and/or handles, which allow a person such as a service technician or first responder to easily and safely gain access without stepping on or damaging any solar modules. These features would also render unnecessary a separate area on a roof for a person to walk in order to reach the solar modules, and thereby allow a full end-to-end design where a maximum amount of roofing surface area can be used for photovoltaic capability.

Another advantage of the present invention might include the use of spacer elements which are positioned in between adjacent modules, such as modules which are next to each other in a horizontal row of a roof assembly. Such spacer elements can be adapted to assist in consistent spacing of modules, which is especially useful when identically sized modules are used and which also makes it easier for identically sized supplemental components, such as border covers, to interface with and cover designated parts of said modules.

The embodiments and descriptions disclosed in this specification are contemplated as being usable separately, and/or in combination with one another.

In some embodiments, an apparatus comprises one or more horizontal supporting beams, which are securable to trusses, rafters, or other supports. The horizontal supporting beams are sized and shaped in a way which allows them to reliably interface with pre-constructed modules. The horizontal supporting beams have adaptations which allow clamping elements to be secured to them. These clamping elements are adapted to interface with one or more modules, and to hold one or more of said modules in place.

In some embodiments, the horizontal supporting beams are tapered in a way which results in an up-roof vertical measurement being shorter than a down-roof vertical measurement.

In some embodiments, the horizontal supporting beams comprise lower protrusions which are adapted to assist in positioning and/or support of modules.

In some embodiments, the lower protrusions are tapered in a way which results in an up-roof vertical measurement being shorter than a down-roof vertical measurement.

In some embodiments, the horizontal support beams are adapted to interface with staggered rows of modules, which are offset with respect to one or more other rows of modules.

In some embodiments, integration covers are adapted to bridge inactive areas between building components and designated surfaces of modules, wherein said designated surfaces of modules comprise solar cells, and wherein said inactive areas comprise conductive wiring and/or air gaps.

In some embodiments, said integration covers can be of multiple sizes, and wherein said integration covers are positioned in a way to alternate between wide and narrow sizes so that edges of said integration covers on one side are aligned with one another, while edges of said integration covers on an opposite side are staggered.

In some embodiments, one or more clamp posts are positioned on the horizontal supporting beams, wherein said clamp posts link said horizontal supporting beams to clamping elements.

In some embodiments, the horizontal supporting beams have one or more clamp posts integrated into them.

In some embodiments, the horizontal supporting beams are adapted to be secured to one or more alignment stoppers, which are adapted to prevent a payload such as a solar module from sliding downward.

In some embodiments, the horizontal supporting beams have one or more alignment stoppers integrated into them, wherein said alignment stoppers are adapted to prevent a payload such as a solar module from sliding downward.

In some embodiments, the alignment stoppers comprise clamp posts.

In some embodiments, the alignment stoppers comprise rings or blocks which fit around the clamp posts.

In some embodiments, the alignment stoppers comprise weatherproofing components.

In some embodiments, flashing is utilized in order to block rain water or other weather elements.

In some embodiments, flashing is adapted for electrical bonding and/or grounding of apparatus components.

In some embodiments, the horizontal supporting beams are adapted for electrical bonding and/or grounding of apparatus components.

In some embodiments, border covers are sized and positioned to cover specifically sized surfaces of pre-constructed modules.

In some embodiments, said specifically sized surfaces of pre-constructed modules comprise conductive wiring.

In some embodiments, said border covers have an asymmetric configuration, and extend further in one direction than an opposite direction relative to a central line between two installed modules.

In some embodiments, said border covers are positioned in proximity to gutters, said gutters being adapted to redirect water and/or other weather elements.

In some embodiments, said gutters are positioned to catch water and/or other weather elements under a border region between two modules.

In some embodiments, said gutters are positioned to deposit water on top of flashing and/or other waterproof material.

In some embodiments, the horizontal supporting beams comprise weatherproofing elements and/or projections.

In some embodiments, support elements are positioned to provide pressure which helps module components to resist bending, compression or distortion.

In some embodiments, the support elements provide pressure on the module components from below.

In some embodiments, one or more horizontal supporting beams comprise attachment slots which are adapted to be securable to building elements.

In some embodiments, features of one or more horizontal supporting beams allow them to be utilized with grab steps and/or handles.

In some embodiments, said features of one or more horizontal supporting beams comprise clamp posts and/or clamping elements which are adapted to interface with grab steps and/or handles.

In some embodiments, said grab steps and/or handles are integrated with said horizontal supporting beams.

In some embodiments, said grab steps and/or handles are adapted to be reversibly attached to clamp posts and/or clamping elements.

In some embodiments, said grab steps and/or handles are adapted to be folded and/or rotated.

In some embodiments, spacer elements are positioned in between adjacent modules in a row and are adapted to block movement of modules, hence determining module positioning and spacing.

### BRIEF DESCRIPTION OF THE DRAWINGS

FIGS. 1A-1J show an example embodiment of the invention in the form of a roof assembly.

FIGS. 2A-2B show a lower left corner of the roof assembly shown in FIGS. 1A-1J after all components have been installed.

FIGS. 2C-2D show a side profile cross-sectional view of the roof assembly from FIGS. 1A through 2B.

FIGS. 3A-3B show cross-sectional views of alternative designs for supporting module frames when clamped.

FIG. 4A shows top views of solar modules having photovoltaic capability.

FIGS. 4B-4C shows a cross-sectional view of a border region between two framed modules.

FIG. 4D shows a cross-sectional view of a border region between two frameless modules.

FIGS. 5A-5B show a side cross-sectional view of an alternative embodiment, which allows alternative integration of horizontal supporting beams and modules with other parts of a roof assembly.

FIG. 5C-5D show a rotated cross-sectional view of the alternative embodiment from FIGS. 5A and 5B.

FIGS. 5E-5F show designs for a horizontal supporting beam.

FIG. 6 shows a cross-sectional area which depicts various grounding-related components and adaptations.

FIGS. 7A-7B show side views of an embodiment with specially sized and tapered sections of apparatus components.

FIGS. 8A-8B show views of a roof assembly to which grab steps have been added.

### DETAILED DESCRIPTION OF THE INVENTION

The following detailed description of the invention refers to the accompanying figures. The description and drawings do not limit the invention; they are meant only to be illustrative of example embodiments. Other embodiments are also contemplated without departing from the spirit and scope of the invention.

Referring now to the drawings, embodiments of the invention are shown and disclosed.

In this disclosure, the terms “solar panel” and “solar module” are interchangeable.

In this disclosure, the terms “up-roof” and “down-roof” will be used to describe relative positions of components. For example, a solar module which is positioned further up a roof than a clamp will be referred to as an “up-roof module”, and a solar module positioned further down a roof than that same clamp will be referred to as a “down-roof module”.

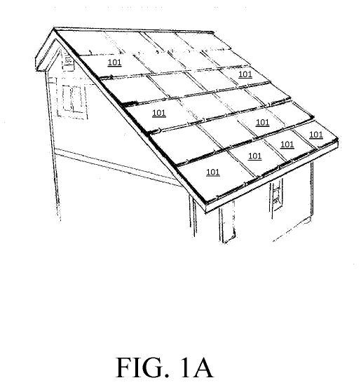

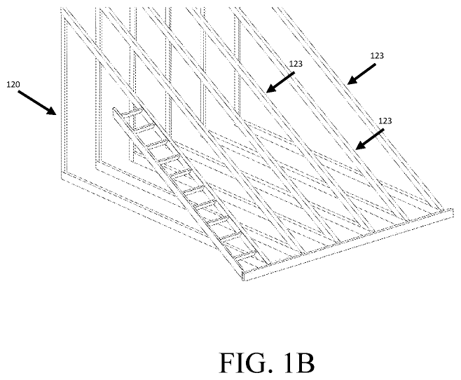

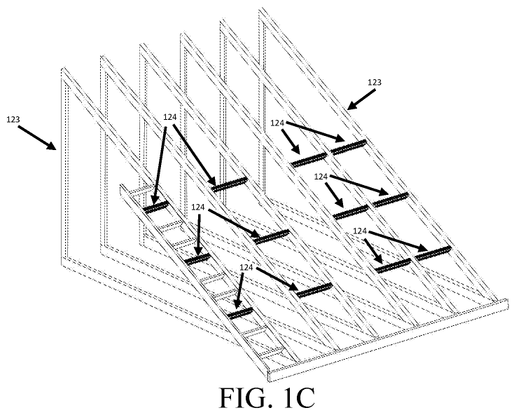

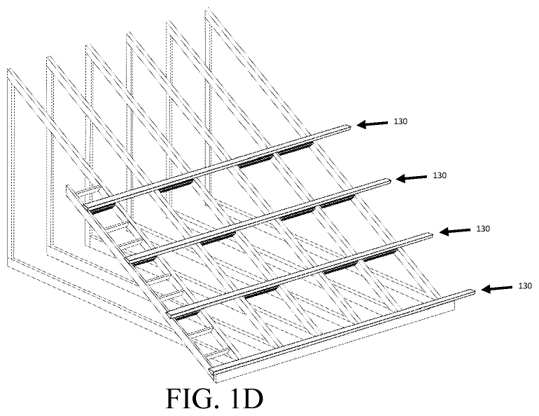

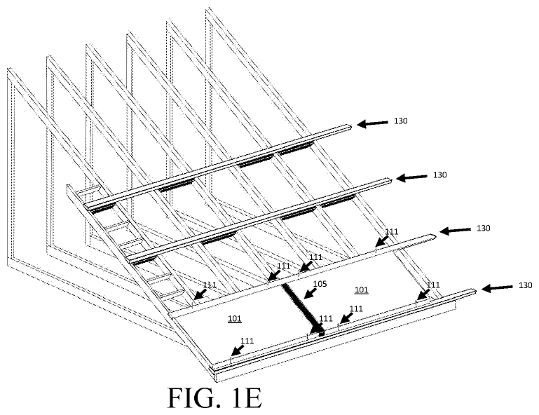

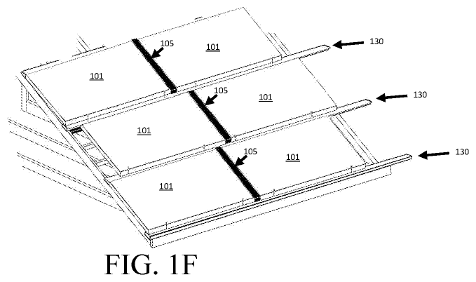

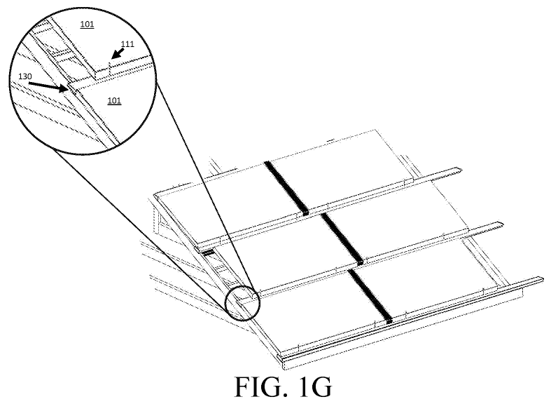

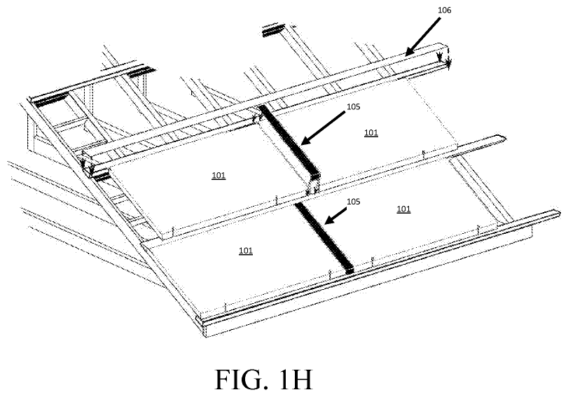

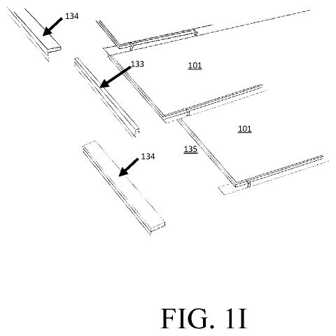

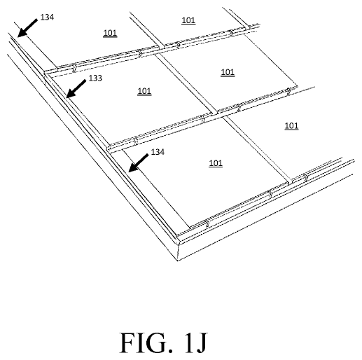

FIG. 1A shows an example embodiment of the invention in the form of a roof assembly, which comprises horizontal supporting beams and clamps which operate together to hold solar modules in place on a building. Components disclosed in this embodiment include modules 101, which comprise frames and solar-powered photovoltaic surfaces, and are adapted to convert solar energy into electricity. Note that in this embodiment, the solar modules are oriented so that they are wider horizontally than vertically (“landscape orientation”); however, embodiments are also contemplated wherein solar modules can be oriented so that they are wider vertically than horizontally (“portrait orientation”).

FIG. 1B shows a conventional roof-supporting structure before solar modules or a roof assembly are placed on it. Visible here are trusses which comprise vertical elements 120 and rafters 123.

FIG. 1C shows the structure from FIG. 1B with frame supports 124 added to it. The frame supports 124 are used to support metal frames of modules 101 from FIG. 1A, in embodiments where metal-framed modules are used. (Note that frameless solar modules are also contemplated, and are disclosed elsewhere in this application.) The frame supports 124 act to help prevent metallic frames, such as those of down-roof modules, from bending when the metallic frames are compressed by clamp components of the invention.

FIG. 1D shows the structure from FIG. 1C with horizontal supporting beams 130 added, in addition to frame supports 124 which were added earlier. Note that these components can be secured to rafters 123 and each other by using means known in the area of building construction, such as nails or screws.

FIG. 1E shows the structure from FIG. 1D with two modules 101 and a vertical border cover 105 added, as well as flashing 106 which has been placed over one of the horizontal supporting beams and a row of modules 101. Also appearing in this view are two rows of clamp posts 111. One possible function of clamp posts 111 is to block each module from sliding down a roof during installation. Because clamp posts 111 can hold or block a module, a technician can easily place each module at or near its eventual location before installing clamps to secure the modules.

FIG. 1F shows the structure from FIG. 1E with an additional four modules 101 installed, making six altogether.

FIG. 1G shows a detail view of the structure from FIG. 1F. Note in this view that horizontal supporting beam 130 is tapered to make an up-roof end vertically shorter than a down-roof end. This design helps set an angle of each module 101 which rests on horizontal supporting beam 130, facilitating eventual overlap and waterproofing as will be disclosed in subsequent figures.

FIG. 1H shows the roof assembly as two components are being added to it, a vertical border cover 105 and horizontal flashing 106.

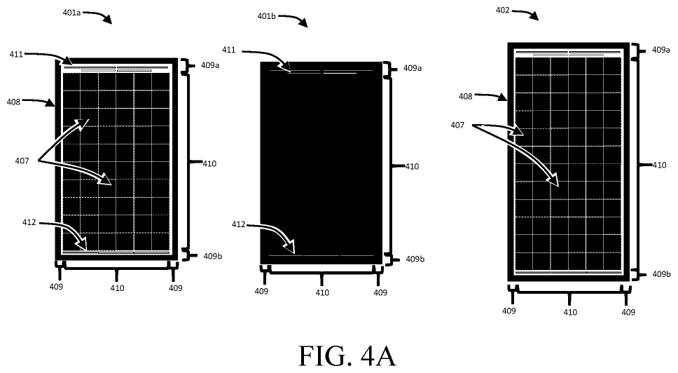

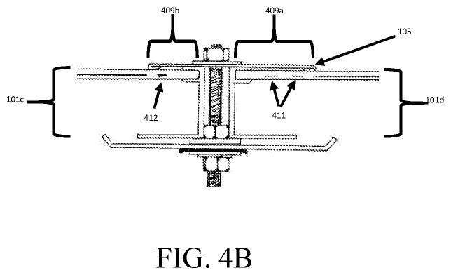

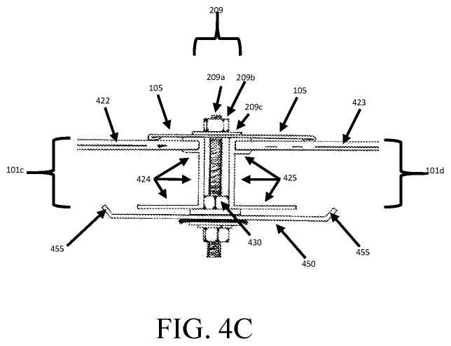

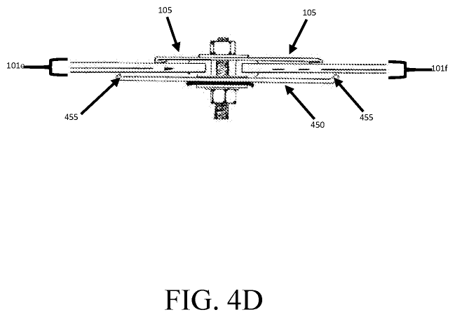

FIG. 1I shows a roof assembly to which eave covers can be attached. In this view, narrow-edge eave cover 133 is sized to cover an inactive “dead zone” region on a standard solar module 151, while wide-edge eave cover 134 is sized to cover both an air gap 135 and an inactive “dead zone” area which is part of a standard solar module 801. Note that in a solar array installation, the inactive “dead zone” area on a solar module could correspond to reference numeral 409a or 409b from FIG. 4A.

FIG. 1J shows the roof assembly from FIG. 1I after eave covers have been placed correctly.

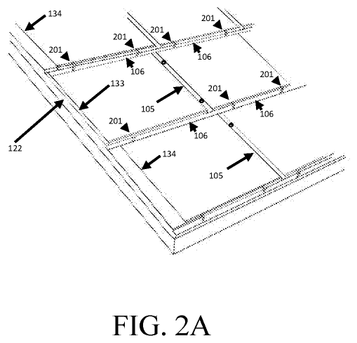

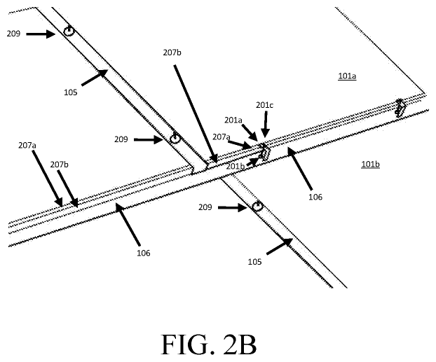

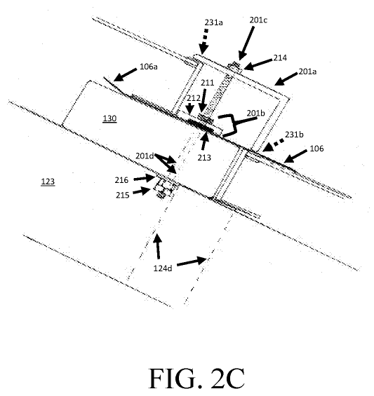

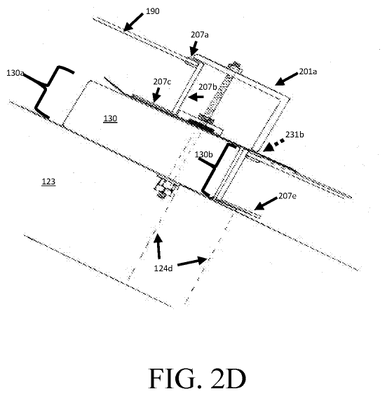

FIG. 2A shows a lower left corner of the roof assembly shown in FIGS. 1A-1J after all components have been installed. This view depicts clamps 201, which are positioned on clamp supports 111 (shown in earlier drawings) and are adapted to secure modules in place. Each clamp 201 comprises a component which presses down on an up-roof module, on flashing, and thereby on a down-roof module which is partially under said flashing; each clamp 201 also comprises other components which secure the clamp to the roof assembly (shown in other figures in more detail). This view also shows a narrow edge eave cover plate 133, and wide edge eave cover plates 134. In this embodiment, each wide edge eave cover plate 133 is adapted to cover both empty space (an “air gap”) and part of an adjacent module, while each narrow edge eave cover plate 134 is adapted to cover only a small section of an adjacent module. (Note that additional embodiments are contemplated where every row of modules is positioned all the way at a side edge of a roof, as opposed as the embodiment shown where some rows are offset.) This view also shows side eaves facia plate 122. Additionally shown are vertical border covers 105 and horizontal flashing 106.

FIG. 2B shows a zoomed-in section of the view in FIG. 2A. This view shows three components of the clamps 201 from FIG. 2A, namely a module-pressing element 201a, a flashing link 201b, and a clamp post 201c. The flashing link 201b can take one of many forms (some of which are disclosed in subsequent drawings), and functions to connect other elements of a clamp 201 to horizontal flashing 106. Here, horizontal flashing 106 comprises a flat piece of metal laid horizontally, which is positioned partially under an up-roof module 101a and partially over a down-roof module 101b. Module-pressing element 201a, here depicted as a right-angled piece of metal, functions to press down on two surfaces—an upper surface of an up-roof module 101a, and an upper surface of flashing 106, hence transmitting pressure through flashing 106 to a down-roof module 101b under the flashing, and thereby helping to hold both modules in place. (FIG. 2C depicts a more detailed view of this arrangement.) In this view, one surface being pressed by module-pressing element 201a is a top surface 207a of a metallic frame component of the up-roof module. This metallic frame component is located at a down-roof end of the up-roof module (and has a downward-side frame component, 207b, also shown in this view). Also shown in this view are vertical border covers 105 and cover locks 209.

FIG. 2C shows a side profile cross-sectional view of the roof assembly from FIG. 2B. This view shows rafter 123, as well as invention components which sit atop multiple rafters as shown in earlier figures. This view also shows components comprising a clamp (shown as 201 in earlier figures), including module-pressing element 201a, flashing link 201b, and clamp post 201c. This view depicts how clamp post 201c is inserted through horizontal supporting beam 130, which will have passages (such as holes, drilled from top to bottom) through which clamp posts 201c can be placed (indicated by dashed lines 201d). In this view, module-pressing element 201a is pressed down when an upper rotating nut 214 is rotated downward around clamp post 201c. Doing so creates downward pressure on an up-roof module (shown at position 231a) and downward pressure on flashing 206, which is transmitted to an upper surface of a down-roof module (shown at position 231b), and thereby acts to hold each module in place. clamp post 201c is secured at its bottom end by lower rotating nut 215 and by washer 216. (Note that, as depicted in FIGS. 1E, 2A and 2B, clamps 201 and clamp posts 111 will be positioned in between rafters 123, so that bottom projections such as lower rotating nut 215 and washer 216 will not be blocked by said rafters 123.) In this embodiment, flashing link 201b comprises rotating nut 211, clamping/alignment block 212, and rubber washer 213. Additionally, clamp post 201c comprises a threaded screw (although other embodiments are contemplated with alternative clamp-supporting elements). Rotation of rotating nut 211 around clamp post 201c puts downward pressure on block 212 and rubber washer 213, creating a watertight seal in that area. In this embodiment, flashing 106 comprises a flange 106a, which projects from an up-roof part of flashing 106 and assists with waterproofing features of the roof assembly.

FIG. 2D shows the same cross-sectional view as FIG. 2C. This view highlights components which comprise each module (labeled as 101 in other figures). Components of said modules 101 include a glass panel 190 which, when installed, faces skyward, as well as a metal frame visible in cross section which comprises top surface 207a and a downward-side surface 207b, as well as a lower surface 207c. When clamping element 201a is pushed downward as described above, it presses on a top surface 207a of an up-roof module and thereby holds it in place. Also shown in this view is horizontal supporting beam 130, which is tapered to be narrower at its up-roof end 130a than at its down-roof end 130b. This tapering causes module 101 and glass panel 190 to rest at an angle which is different from an angle of rafters 123. This tapering and angle thereby adapts horizontal supporting beam 130 in a way that allows more convenient and watertight placement of solar modules, as will be shown in subsequent figures. Note also in this view dotted lines 124d, which represent an outline of the frame supports 124 shown in FIGS. 1C-1E. In this embodiment, the frame supports 124 can be positioned in a way that allows access of lower frame component 207e from below, such as in this view where lower frame component 207e is partially blocked but partially exposed from below; this facilitates additional functionality, such an ability to connect wiring and/or other conductive components and thereby ground module frames more easily.

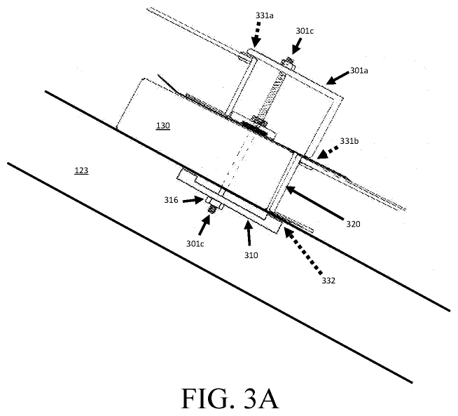

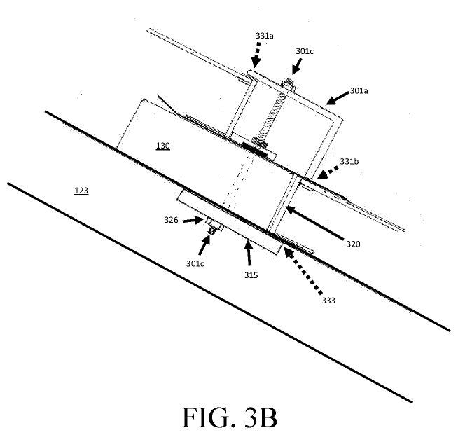

FIG. 3A shows a cross-sectional view of an alternative design for supporting module frames when clamped. In this view, lower nut 316 is rotated around clamp post 301c and puts upward pressure on frame-supporting ring 310, which in turn supports module frame 320 from its bottom, applying upward pressure at position 332 which counteracts downward pressure from clamping element 301a at position 331b. As such, frame-supporting lever 310 acts to prevent distortion or bending of module frame 320, which could otherwise result due to upward normal pressure from rafters 123 combined with simultaneous downward pressure from clamps 201 positioned in between said rafters.

FIG. 3B shows a cross-sectional view of an additional alternative design for supporting module frames when clamped. In this view, lower nut 326 is rotated around clamp post 301c and puts upward pressure on frame-supporting block 315, which in turn supports module frame 320 from its bottom, applying upward pressure at position 333 which counteracts downward pressure from clamping element 301a at position 331b. In this way, frame-supporting block 315 acts to prevent distortion or bending of module frame 320, which could otherwise result when upward normal pressure from rafters 123 combines with simultaneous downward pressure from clamps 201 positioned in between said rafters.

FIG. 4A shows top views of solar modules having photovoltaic capability. Most module manufacturers today build modules in two standard sizes: 60-cell modules and 72-cell modules. Here, module 401a represents a 60-cell module with a white backing and module 401b represents a 60-cell module with a black backing. Module 402 represents a 72-cell module with a white backing. Each module comprises solar cells 407, which sit on top of the white backing or black backing of the module (depending on which is used), and are adapted to absorb solar light. The solar cells 407 collect energy and typically are wired together in each module, either in series or some combination of series and parallel. In this figure, the solar modules comprise frames 408, although frameless module designs are also contemplated for use with the present invention. Also shown are inactive “dead zone” areas 409, 409a, and 409b, which have no solar cells and do not collect solar energy, as well as “active zones” 410 which do contain solar cells. Also shown are junction-box-end interconnect conductors 411, which interface with a junction box component (not shown), and non-junction-box-end interconnect conductors 412. (In typical solar module construction, 411 and 412 will be visible and will therefore interfere with module aesthetics in the absence of aesthetic covering.) In typical standard solar modules, junction-box-end interconnect conductors 411 will be in a “dead zone” area 409a, which is larger-sized than a similar “dead zone” area 409b at an opposite end of the solar module containing non-junction-box-end interconnect conductors 412. Because of the respective sizes of 409a and 409b, any aesthetic covering or weather-proof covering requires specially sized covers adapted to fit these areas, or requires a specially sized cover adapted to fit over both areas at once when solar modules are laid end-to-end. FIGS. 4B-4D show such an example of a border cover which, due to its particular size and asymmetric design, is able to cover simultaneously a larger “dead zone” area 409a of one solar module and a smaller “dead zone” area 409b of an adjacent module.

FIG. 4B shows a cross-sectional view of a border region between two framed modules, 101c and 101d, viewed in a vertical direction (here meaning either looking in an up-roof direction or a down-roof direction). Shown in this view is vertical border cover 105 (also shown in FIG. 2B). Also shown in this view are elements and regions from FIG. 4A which vertical border cover is adapted to cover and protect, including area 409b which contains non-junction-box-end interconnect conductors 412, and area 409a which contains junction-box-end interconnect conductors 411. Note that vertical border cover 105 is adapted to be asymmetrical, due to the fact that standard solar modules may have “dead zone” regions with conductive wires which are different sizes at different ends of the standard solar modules; as such, vertical border cover 105 is sized on each end to provide coverage of these regions (for both waterproofing and aesthetic purposes) without covering any solar cells.

FIG. 4C shows additional details from the cross-sectional view of FIG. 4B. Visible in this view are cross sections of modules 101c and 101d which are positioned next to each other in a horizontal row on a roof assembly. Depicted in this view are a module 101c which comprises solar panel glass 422 and frame 424, and an adjacent module 101d which comprises solar panel glass 423 and frame 425. This view also shows a vertical border cover 105 and a cover lock 209 (also shown in FIG. 2B). Here, the cover lock 209 comprises vertical threaded screw 209a, vertical nut 209b, and washer 209c. The vertical border cover 105 functions to provide protection from rain water and other elements by covering a border region in between the module 101c and its adjacent module 101d. Note that vertical border cover 105 can be sized to cover “dead” areas of the modules without blocking any of the modules' solar cells, as depicted in FIGS. 4A-4B. The cover lock 209 holds the vertical border cover 105 in position after vertical nut 209b is rotated around vertical threaded screw 209a. An optional washer 209c functions to provide additional waterproofing. Also, washer 209c can be sized to distribute pressure from vertical nut 209b downward onto upper surfaces of the module 101c and the adjacent module 101d, thereby holding these modules in place and providing additional stability to the roof assembly. This can be seen in the view depicted, where washer 209c is wide enough to exert downward pressure on upper surfaces of frame 424 and frame 425 when vertical nut 209b is tightened. Shown also in this view is border gutter 450, which is adapted to catch water or other weather elements in situations where parts of the modules or roof assembly (such as joints between solar panel glass and a frame of a module) are, for whatever reason, not completely watertight. Here, border gutter 450 extends beyond and below module frames 424 and 425, ensuring that it will catch water which runs off of said module frames. In this view, border gutter 450 comprises gutter flanges 455, which angle upward and prevent unwanted water from spilling over a right edge or a left edge of border gutter 450. Additionally, border gutter 450 is adapted to sit on top of a frame support 124 (shown in earlier figures) in embodiments where frame supports 124 are used. In embodiments where frame supports 124 or other continuous horizontal supports are not present, border gutter 450 will instead be supported on its up-roof end by module frames 424 and 425. At a lower/down-roof end, border gutter 450 extends past flange 106a and can hence deposit water in a way that causes the water to fall onto flange 106a (shown in earlier figures) and harmlessly run downward from there. Also shown in this view is spacer nut 430, which blocks horizontal movement of adjacent modules, and thereby makes it easier for an installer to maintain consistent spacing between adjacent modules. Spacer nut 430 can also be rotated around vertical threaded screw 209a in a manner which secures other components such as border gutter 450.

FIG. 4D shows a cross-sectional view of a border region between two frameless modules. (Note that embodiments which use framed modules are also contemplated, as shown in earlier figures.) Shown in this view are vertical border cover 105, frameless solar module 101e, frameless solar module 101f, and border gutter 450 which comprises gutter flanges 455. Just as in FIGS. 4B and 4C, vertical border cover 105 is sized to precisely cover differently sized “dead zone” areas on a left side and a right side, and gutter flanges 455 assist border gutter 450 with its task of channeling away water or other weather elements.

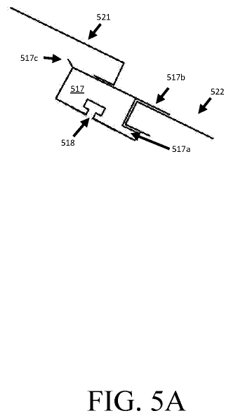

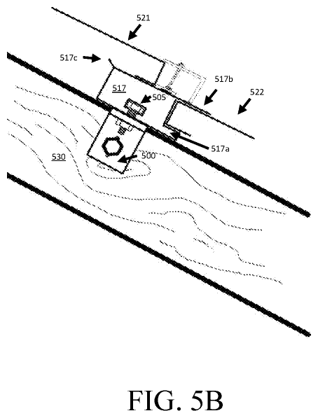

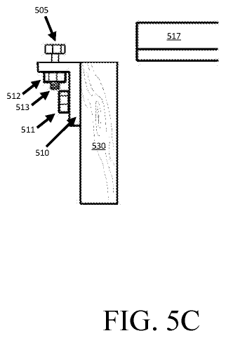

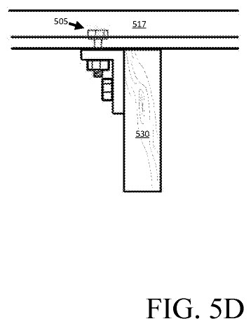

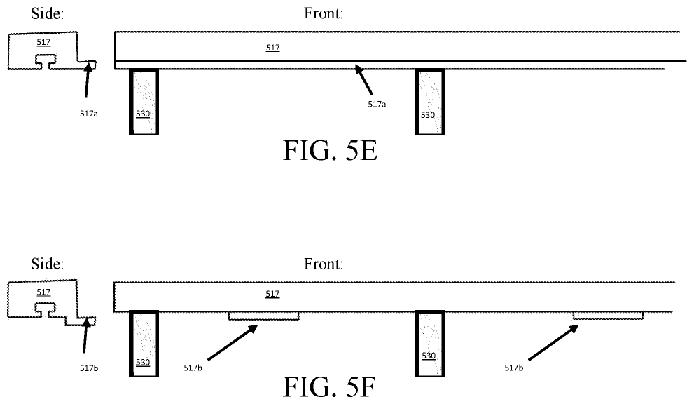

FIG. 5A shows a side cross-sectional view of an alternative embodiment, which allows alternative integration of horizontal supporting beams and modules with other parts of a roof assembly. Depicted in this view is an alternative design for a horizontal supporting beam 517, which is here adapted to have a specially shaped bottom slot 518, where said bottom slot runs along the horizontal supporting beam 517 for its full length, and is open on its left and right sides. Also shown in this view are a specially adapted bottom extrusion 517a, a front waterproof protrusion 517b, and a back waterproof protrusion 517c which are all integrated into horizontal supporting beam 517. Shown also in this view are an up-roof module 521 and a down-roof module 522.

FIG. 5B shows a side cross-sectional view of the alternative embodiment from FIG. 5A, with additional components added. Depicted are an up-roof module 521 and a down-roof module 522. Also shown is L-shaped bracket 500, atop which is bolt head 505. Here, horizontal supporting beam 517 is adapted to have a shaped bottom slot (labeled 518 in the previous figure), which is adapted to slide horizontally over bolt head 505. Doing so secures horizontal supporting beam 517 to the L-shaped bracket 500, which in turn is secured to rafter 530. Additionally in this view, up-roof module 521 rests on top of horizontal supporting beam 517. Also, an upper end of down-roof module 522 rests on a specially adapted bottom extrusion 517a, a component of horizontal supporting beam 517. This allows the module's upper end to be supported by horizontal supporting beam 517 as opposed to by rafters 530 or trusses or frame supports (not pictured).

FIG. 5C shows a rotated cross-sectional view of the alternative embodiment from FIGS. 5A and 5B. This view indicates how the L-shaped bracket 500 and the bolt head 505 from FIG. 5A operate to secure horizontal supporting beam 517 in place. In this view, the L-shaped bracket comprises a vertical part 510, which is secured to rafter 530 (viewed here from its narrow end) by using bolt 511.

FIG. 5D shows the alternative embodiment from FIGS. 5A-5C, after horizontal supporting beam 517 has been slid to cover and surround a bolt head 505 of an L-shaped bracket.

FIG. 5E shows a design for horizontal supporting beam 517 from FIGS. 5A-5D wherein bottom extrusion 517a runs full-length along horizontal supporting beam 517.

FIG. 5F shows an alternative design for horizontal supporting beam 517, in which there are multiple bottom projections 517b. With this design, bottom projections 517b can be spaced in a way that causes them to be positioned between rafters 530. Note also that bottom projections 517b can extend further downward than top surfaces of rafters 530.

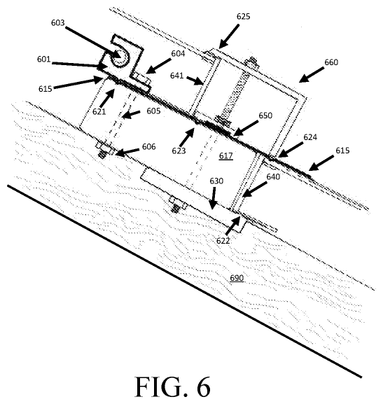

FIG. 6 shows a cross-sectional area which depicts various grounding-related components and adaptations. Shown in this figure are a grounding lug 601, a cross-section of a bare wire 603, an upper securing nut 604, a securing rod 605, a lower securing nut 606, and flashing 615. In this design, bare wire 603 is adapted to be electrically connected to the earth or to another electrical ground. Note that in some embodiments, horizontal supporting beam 617 might be made of metal or another conductor, and can assist in grounding of other components. Also shown in this figure are points at which electrically conductive components contact each other in a manner that assists in an eventual connection to an electrical ground via flashing 615, including: electrical connection 621, which links grounding lug 601 to flashing 615; electrical connection 622, which links frame-supporting block 630 to module frame 640; electrical connection 623, which links clamping/alignment block 650 to flashing 615; electrical connection 624, which links clamping element 660 to flashing 615; and electrical connection 625, which links clamping element 660 to module frame 641. Electrical connections in this view can comprise components and adaptations known in the art, such as direct contact, physical conducting pieces, and/or deformed surfaces which guarantee a contact connection. Note that when the invention is implemented as an array with multiple solar modules and/or 617, each module can be removed without interrupting electrical connections that other modules require for grounding.

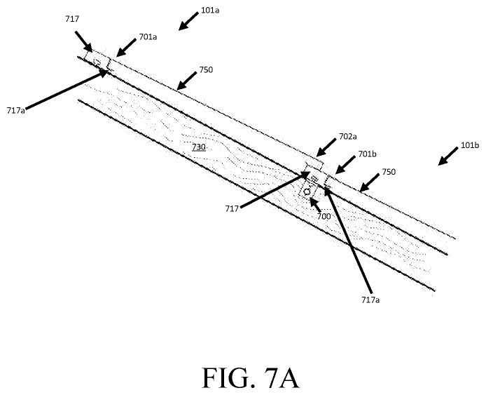

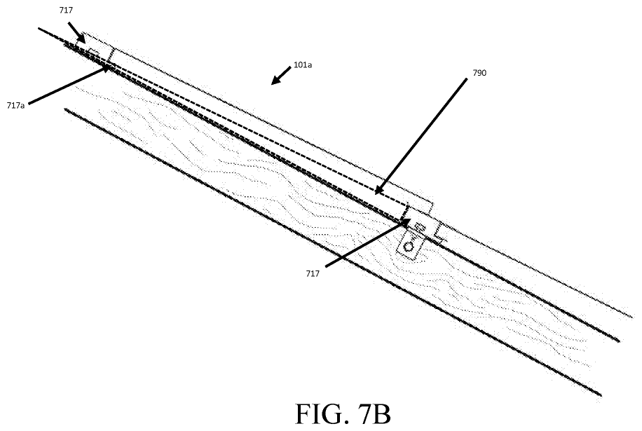

FIG. 7A shows a side view of an embodiment in which tapered sections of apparatus components are sized and shaped to support modules 101a and 101b. Here the modules shown comprise solar glass 750, and are supported by horizontal supporting beams 717 and bottom extrusions 717a, which in turn are supported by rafters 730.

FIG. 7B shows a zoomed-in view of the embodiment from FIG. 7A, where an invisible triangle 790 designates shapes that horizontal supporting beams 717 and bottom extrusion 717a must take in order to properly angle and position the module 101a. Note that in addition, embodiments are also contemplated in which bottom extrusion 717a is not present, and modules in these embodiments will comprise an up-roof end which rests directly on rafters and/or other supports rather than on bottom extrusion 717a. (FIGS. 2C-2D and 3A-3B depict examples of such embodiments.)

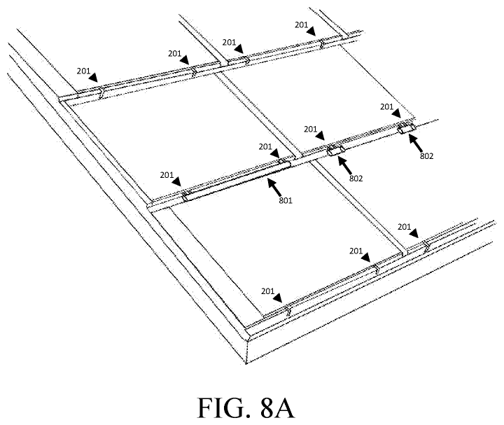

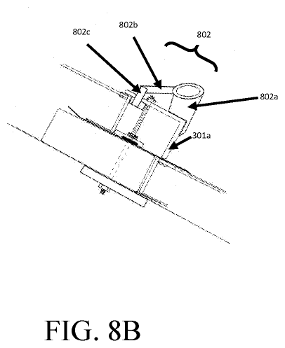

FIG. 8A shows a roof assembly to which grab steps have been added. Clamps 201, shown in earlier figures, have adaptations which allow attachment of wide grab step 801 and narrow grab steps 802. Grab steps or handles can function as steps, footholds and/or handholds when a homeowner, technician, firefighter, first responder, or other person needs to move from place to place on the roof assembly. Note that embodiments are contemplated where grab steps or handles are integrated into other roof assembly components, such as embodiments where they are integrated into horizontal support beams. Note also that embodiments are contemplated where grab steps or handles can be reversibly attached to other roof assembly components, such as clamps 201.

FIG. 8B shows a side profile cross-sectional view of a narrow grab step 802 from FIG. 8A. Here, narrow grab step 802 comprises gripping cylinder 802a, intermediate member 802b, and anchor member 802c. In this embodiment, anchor member 802c is adapted to be secured to clamping element 301a, which in turn is secured using other components as shown in previous figures. Note that embodiments are contemplated where intermediate member 802b can rotate about anchor member 802c, allowing folding and/or rotation. Rotational and/or folding functionality of a grab step or handle can be useful for a number of reasons, such as conveniently placing them out of the way into a configuration which does not block sunlight from reaching solar cells of roof modules.

I claim:

1. An apparatus which comprises one or more horizontal supporting beams, which are securable to trusses, rafters, or other supports. The horizontal supporting beams are sized and shaped in a way which allows them to reliably interface with pre-constructed modules. The horizontal supporting beams have adaptations which allow clamping elements to be secured to them. These clamping elements are adapted to interface with one or more modules, and to hold one or more of said modules in place.

2. An apparatus as in claim 1, wherein the horizontal supporting beams are tapered in a way which results in an up-roof vertical measurement being shorter than a down-roof vertical measurement.

3. An apparatus as in claim 1, wherein the horizontal supporting beams comprise lower protrusions which are adapted to assist in positioning and/or support of modules.

4. An apparatus as in claim 1, wherein the lower protrusions are tapered in a way which results in an up-roof vertical measurement being shorter than a down-roof vertical measurement.

5. An apparatus as in claim 1, wherein the horizontal support beams are adapted to interface with staggered rows of modules, which are offset with respect to one or more other rows of modules.

6. An apparatus as in claim 1, wherein integration covers are adapted to bridge inactive areas between building components and designated surfaces of modules, wherein said designated surfaces of modules comprise solar cells, and wherein said inactive areas comprise conductive wiring and/or air gaps.

7. An apparatus as in claim 6, wherein said integration covers can be of multiple sizes, and wherein said integration covers are positioned in a way to alternate between wide and narrow sizes so that edges of said integration covers on one side are aligned with one another, while edges of said integration covers on an opposite side are staggered.

8. An apparatus as in claim 1 wherein one or more clamp posts are positioned on the horizontal supporting beams, wherein said clamp posts link said horizontal supporting beams to clamping elements.

9. An apparatus as in claim 1, wherein the horizontal supporting beams have one or more clamp posts integrated into them.

10. An apparatus as in claim 1, wherein the horizontal supporting beams are adapted to be secured to one or more alignment stoppers, which are adapted to prevent a payload such as a solar module from sliding downward.

11. An apparatus as in claim 1, wherein the horizontal supporting beams have one or more alignment stoppers integrated into them, wherein said alignment stoppers are adapted to prevent a payload such as a solar module from sliding downward.

12. An apparatus as in claim 10, wherein the alignment stoppers comprise clamp posts.

13. An apparatus as in claim 10, wherein the alignment stoppers comprise rings or blocks which fit around the clamp posts.

14. An apparatus as in claim 10, wherein the alignment stoppers comprise weatherproofing components.

15. An apparatus as in claim 1, wherein flashing is utilized in order to block rain water or other weather elements.

16. An apparatus as in claim 1, wherein flashing is adapted for electrical bonding and/or grounding of apparatus components.

17. An apparatus as in claim 1, wherein the horizontal supporting beams are adapted for electrical bonding and/or grounding of apparatus components.

18. An apparatus as in claim 1, wherein border covers are sized and positioned to cover specifically sized surfaces of pre-constructed modules.

19. An apparatus as in claim 18, wherein said specifically sized surfaces of pre-constructed modules comprise conductive wiring.

20. An apparatus as in claim 18, wherein said border covers have an asymmetric configuration, and extend further in one direction than an opposite direction relative to a central line between two installed modules.

21. An apparatus as in claim 18, wherein said border covers are positioned in proximity to gutters, said gutters being adapted to redirect water and/or other weather elements.

22. An apparatus as in claim 21, wherein said gutters are positioned to catch water and/or other weather elements under a border region between two modules.

23. An apparatus as in claim 21, wherein said gutters are positioned to deposit water on top of flashing and/or other waterproof material.

24. An apparatus as in claim 1, wherein the horizontal supporting beams comprise weatherproofing elements and/or projections.

25. An apparatus as in claim 1, wherein support elements are positioned to provide pressure which helps module components to resist bending, compression or distortion.

26. An apparatus as in claim 25, wherein the support elements provide pressure on the module components from below.

27. An apparatus as in claim 1, wherein one or more horizontal supporting beams comprise attachment slots which are adapted to be securable to building elements.

28. An apparatus as in claim 1, wherein features of one or more horizontal supporting beams allow them to be utilized with grab steps and/or handles.

29. An apparatus as in claim 28, wherein said features of one or more horizontal supporting beams comprise clamp posts and/or clamping elements which are adapted to interface with grab steps and/or handles.

30. An apparatus as in claim 28, wherein said grab steps and/or handles are integrated with said horizontal supporting beams.

31. An apparatus as in claim 28, wherein said grab steps and/or handles are adapted to be reversibly attached to clamp posts and/or clamping elements.

32. An apparatus as in claim 28, wherein said grab steps and/or handles are adapted to be folded and/or rotated.

33. An apparatus as in claim 1, wherein spacer elements are positioned in between adjacent modules in a row and are adapted to block movement of modules, hence determining module positioning and spacing.
